(19) United States
(12) Patent Application Publication
(10) Pub. No.: US 2012/0312564 A1
(43) Pub. Date: Dec. 13, 2012

(54) METHOD AND DEVICE FOR QUENCHING OIL AND PETROLEUM PRODUCTS IN TANKS

(76) Inventors: Vladimir Ivanovich Seliverstov, Moskovskaya (RU); Vladimir Llyich Stenkovoy, Moskovskaya (RU); Anatoliy Nikolaevich Baratov, Moskovskaya (RU); Valeriy Leonidovich Bakharev, Moskovskaya (RU); Pavel Gennadievich Veretinskiy, Moskovskaya (RU); Dmitriy Dmitrievich Osmakov, Moskovskaya (RU); Lev Vladislavovich Rzhavskiy, Moskovskaya (RU); Galina Vladimirovna Trubnikova, Moskovskaya (RU)

(21) Appl. No.: 13/580,967

(22) PCT Filed: Dec. 14, 2010
(86) PCT No.: PCT/RU10/00754

§ 371 Date: Aug. 24, 2012

(30) Foreign Application Priority Data
Feb. 24, 2010 (RU) 2010106910

(51) Int. Cl. A62C 3/06; A62C 2/00

(52) U.S. Cl. 169/46; 169/68

(57) ABSTRACT

Method and device for quenching oil and petroleum products in a tank in which a fire-extinguishing mixture is fed through a floating sprinkler surfacing above a burning liquid surface. A floating sprinkler connected to a discharge pipeline via an opening-closing device with an injector is installed under the burning liquid layer. After a fire alarm signal is sent, the opening-closing device on the injector is opened, and the fire-extinguishing mixture is fed through the pipeline and the floating sprinkler under the layer or onto the surface of the burning liquid in the form of compact jets from the center to the periphery. The floating sprinkler surfaces above the surface of the burning liquid.

### CROSS-REFERENCE TO RELATED APPLICATION

This application claims the benefit of the priority filing date in PCT/RU2010/000754 and referenced in WIPO Publication No. WO/2011/105926. The earliest priority date claimed is Feb. 24, 2010.

### FEDERALLY SPONSORED RESEARCH

None

### SEQUENCE LISTING OR PROGRAM

None

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The invention pertains to the field of fire fighting technology and proposes a method and device for quenching oil and petroleum products, and flammable (FL) and highly inflammable (HIL) liquids, in vertical steel tanks (VST) and vertical steel tanks with a fixed roof and a pontoon (VSTP).

Known is the method for quenching burning liquids comprising feeding granulated solid carbon dioxide, with granules 3-4 cm in diameter, under the fire. Granules are fed under the layer of burning liquid in compact portions (USSR Certificate of Authorship 1687266 of Oct. 30, 1991). Among the shortcomings of quenching burning liquids with solid carbon dioxide are the difficulty of feeding it into the burning tank via filling-draining process pipes, high consumption of the material for extinguishing the fire (at least 0.7 kg/m³) and storing the material in insulated tanks.

Also known is the method for gas-powder quenching using a dry-powder fire extinguisher designed for extinguishing local fires which comprises a cylinder-gun with fire-extinguishing powder, a gas generating chamber with an explosive charge and a pyrotechnic squib, and an automatic control system. The fire extinguisher is described in VNIIPO MVD RF SSSR [All-Union Fire Safety Scientific Research Institute, Ministry of Internal Affairs, Russian Federation, USSR] recommendations (1978, pp. 12, 16, 30, FIGS. 5 and 4). Among the method shortcomings are:

higher ratio of the device weight to the weight of its fire-extinguishing charge;
high pressure (100 MPa) and high temperature (1500-2000°) in the gas generating chamber;
high pressure (10 MPa) in the fire extinguisher cylinder;
it is difficult to use this quenching method because of the high exhaust velocity (as high as 250 m/s) of the fire extinguishing composition and its higher danger to operating personnel.

Known is a method for extinguishing fire per RF Patent No. 2129031 of Aug. 18, 1992, comprising feeding onto the burning surface a solid-fuel aerosol-forming substance in the form of foam-producing granules or foam-producing sticks with a specific gravity of 800 kg/m³, coated with a waterproofing compound with an ignition temperature of 120-140° C. According to the invention, the compound is fed manually (small bags with foam-producing granules are thrown onto the burning surface of a tank with oil) or via a hose from a vehicle. In our opinion, this method cannot be implemented in practice because of the very high danger of feeding a solid-fuel or pyrotechnic composition with the aforementioned parameters onto the burning tank surface, especially with a 375 m² burning surface. The diameter of an RVS-5000 tank is 21.1 m, and the burning area is 356 m². In a fire, the flame height is equal to 1-2 diameters. So if the flame height is equal to the diameter, i.e., 21.1 m, the flame volume is 7511.6 m³. According to the description, 24 kg of 8-10 mm diameter foam-producing granules with the density of 600 kg/m³ would only cover 1% of the burning surface area, and concentration of the generated aerosol (provided the utilization factor of the compound is equal to one) will be 240000 g: 7511.6 m³=3.19 g/m³, whereas the authors quote C [symbol] =63 g/m³.

If one takes into account the authors' statement that the volume of released gases is 1600 times higher than the volume of foam-producing sticks, the volume of combustion products would be 64 m³, which is 0.85% of the flame volume. No such fire-extinguishing substances with a fire-extinguishing concentration of 3.19 g/m³, or 0.85% by volume, or 24 kg: 356 m²=0.067 kg/m² have been found so far; therefore this method cannot be implemented in practice.

Also known is a method for extinguishing fires in tanks per RF Patent No. 2096053 A62C 2/00 of Aug. 5, 1994. The essence of this method is burning a solid-fuel composition (SFC) and feeding the gas-aerosol mixture to a burning surface under cooled conditions from the bottom up, wherein cooling is performed in 2 steps. During the first step, combustion products of a solid-fuel composition are cooled in a water pipeline or brine is fed to it. During the second step, the remaining portion of the gas-aerosol mixture (GAM) that has not dissolved, settled or condensed in the pipeline, bubbles through a layer of flammable or highly inflammable liquid towards the burning surface. The specific consumption of fire-extinguishing substance with respect to burning surface was 0.2 kg/m² with a burning area of 1 m², an HIL volume of 0.75 m³, and an HIL flame height of 75 m.

The main shortcoming of this method is a higher fire danger (the use of pyrophoric SFC in high fire hazard facilities), thermal pyrolysis of oil and petroleum products by combustion products, as well as a relatively high consumption of fire-extinguishing composition during the bubbling of GAM in full-scale VST (vertical steel tanks). Thus, for instance, RVS-5000 tanks most often used in the Russian Federation have a volume of 5000 m³, a liquid surface diameter of 22.8 m, and a stored liquid column height of 11.92. The liquid surface diameter is 408 m². Hence, for uniform distribution of GAM over an RVS-5000 tank with a liquid surface under full-scale conditions, it is necessary, in addition to the steps described in the Patent, to use a pipe reamer for bubbling the GAM, wherein the diameter d₀ of bubbler holes is derived from the following formula:

$${4 [ \frac{g ( - {ρ}_{r} )}{} ]}^{1 / 2} \leq {d}_{0} < 29 \times \frac{ {{ρ}_{r} [ H g / {P}_{a} + 1 ]}^{3}}{} \qquad ( 1 )$$

where [symbol] is the flammable liquid coefficient of surface tension;
pr is the density of gaseous combustion products;
H is the height of the liquid column about the bubbler;
Pa is atmospheric pressure; and
g is the acceleration of gravity;
and center distance L between the centers of bubbler holes is found from the following relation:

$$L > {[ \frac{6 {d}_{0} }{g ( - {ρ}_{r} )} ]}^{1 / 3} * [ \frac{H g }{{P}_{a}} + 1 ] \qquad ( 2 )$$

(see Ya. Ye. Geguzin. [symbol] [Bubbles], Moscow, 1985).

According to experimental data (I. V. Belov, Ye. V. Prokolov. [“The Velocity and Shapes of Air Bubbles in Water], PMTF, No. 3, 1968), the average ascent speed of bubbles is uny3≈0.23 m/s at dny3>2 MM. Calculations demonstrate that the optimum diameter of bubbler holes is d₀=3 mm, and the distance between the holes L=9 mm (see RF Patent No. 2126702 A62 C3/06). Thus, to achieve the effect of extinguishing a fire in an RVS-5000 tank, it is necessary to have a bubbler with 50,000 holes.

The loss of fire extinguishing aerosol in pipelines and on coolers is up to 50%, respectively (V. V. Agafonov, N. P. Kopylov. [symbol] [symbol] [symbol] [Aerosol Fire-Extinguishing Units], Moscow, 1999, 302 pp.) As a result, under full-scale conditions, the actual consumption is 0.8 kg/m², and the time to feed a GAM onto the burning liquid surface, taking into account that the operating time of the fire-extinguishing aerosol generator (FAG) would be at least 2 minutes.

Known is a method for extinguishing fire in tanks with highly inflammable (HIL) and flammable (FL) liquids per RF Patent No. 2241508.

Under this method, fire is extinguished by feeding a fire-extinguishing gas-dispersion mixture (GDM) into a combustion zone from the bottom up, and the fire-extinguishing GDM is formed by feeding, at a pressure of least 2 MPa, a gaseous and/or liquefied gas phlegmatizer, and/or a gaseous and/or liquefied homogeneous fire retardant, and/or a hydrocarbon-proof surfactant (S) into a vessel with a powdery or liquid heterogeneous fire retardant that comprises a valve that provides GDM release when pressure in the vessel reaches at least 0.42 MP, through a perforated sprinkler or several sprinklers that provide 180° spraying of the GDM at a rate of at least 1 kg/s in a direction parallel to the surface of the burning liquid and into the upper hemisphere above the liquid surface, with an intensity sufficient for at an least 0.09 kg/m² concentration of the GDM in the center of the flame volume above the burning surface, wherein the mass ratio of the gaseous and dispersed phases of the fire-extinguishing mixture is between 02:1 and 15:1. An inert gas (for instance, CO2, N2, Ar or their mixture) and/or a non-ozone-damaging halogen-hydrocarbon is used as the gaseous component, and as the heterogeneous fire retardant, one uses a fire-extinguishing carbonate-based, and/or chloride-based, and/or alkali- or alkaline-earth-based, and/or ammonium-based powder compound, or a misting solution of orthophosphoric acid.

A GDM is fed simultaneously from generators floating on the surface of the liquid in the tank and located both around the tank perimeter and in its center, wherein the resultant vector of horizontal spraying from the peripheral generators is directed toward the center, the resultant vector from the central generators is directed toward the periphery, the resultant vector of spraying from the periphery generators into the top hemisphere is directed toward the center of the flame volume, and the resultant vector from the centrally located generators is directed from the center of the burning surface toward the periphery at a 90° angle to the above vector.

The main shortcoming of this method is it is not explosion-resistant, i.e., when HIL and/or FL vapors explode, the devices floating on the surface of the liquid in the VST break down and are ejected from the tank.

Known is a method (Patent RU 2355450 2) for quenching highly inflammable and flammable liquids in tanks with a fixed roof or a fixed roof and a pontoon, or in tanks with a floating roof, by feeding a fire-extinguishing gas-dispersion mixture from a fire fighting modular device or a host of devices installed outside the tank or on the floating roof, wherein the gas-dispersion fire extinguishing mixture is formed in 2 steps.

The first step is performed in a vessel, in a pre-combustion chamber with a dispersed heterogeneous chemical fire retardant, by feeding under pressure at least 2.5 MPa, at least one-fifth of a gaseous and/or liquefied fire retardant, or a mixture of a gaseous and/or liquefied phlegmatizer with methyl carbinol, ethyl carbinol, propyl carbinol or their mixture, and/or a 5-20% solution of iodine solution, or an alkaline metal iodide solution, or ammonium, or their mixture in the above solvents—carbinols. Gaseous and/or liquefied components of the mixture are fed into the pre-combustion chamber from a cylinder, or a system of cylinders, or from a gas generator with opening-closing devices (OCD) upon a signal from a fire alarm, or manually through a tubular aerator installed inside the pre-combustion chamber connected via a discharge valve to a secondary accelerating-mixing chamber. The valve opening is at a pressure of at least 0.9 MPa, where a gas-dispersion mixture is finally formed, with a ratio of gaseous and disperse phases between 0.35:1 and 100:1, and a ratio of gaseous and liquefied phlegmatizers is chosen such that pressure in the gas cylinder system is at least 4 MPa at −50°.

In the second step, the gas-dispersion mixture is fed from the accelerating-mixing chamber to a nozzle module which has a shutoff valve that opens the nozzle module. The module comprises a supersonic diffuser with its nozzle-to-diameter ratio such that the nozzle exit pressure is at least 0.1 MPa and the mass flow is at least 15 kg/s. Carbon dioxide and/or fluorocarbons, or sulfur hexafluoride are used as gaseous and/or liquefied phlegmatizer; bromine hydrocarbons and/or iodine-halogen hydrocarbons are used as gaseous and/or liquefied homogeneous retardants; nitrogen or argon are used as gaseous phlegmatizers; and fire extinguishing powders based on alkaline, alkaline-earth or ammonium chlorides, sulfates, phosphates or carbonates are used as a heterogeneous inhibitor.

Known is a method for quenching FL in a tank per RF Patent No. RU 2355450 C2. Among the shortcomings of this method, and its analogue, are difficulties in using it because the sprinkler is located above the FL surface, and at the moment of explosive combustion it breaks down.

Known is a method for extinguishing fire in a tank by feeding a gas-dispersion fire-extinguishing mixture into a liquid combustion zone from the above mentioned device that floats in the center (Patent RU 2258549 of Mar. 2, 2004) which we have chosen as the prototype.

The shortcoming of both the prototype and analogue methods is they are not explosion-resistant.

Known is a device for quenching oil in tanks, comprising a gas-powder injector and/or a gas-liquid injector (foam generator) pump feeding through an opening-closing device FES into a system of ring and radial pipelines. The pipelines are located in oil horizontally with respect to the bottom of the tank and connected to a system of vertical pipes that have nozzle sprinklers in their top area that extend above the oil surface; the sprinklers make it possible to feed a fire-extinguishing substance (FES) above he surface of burning FL (U.S. Pat. No. 5,573,068, IPC A 62 C 3/06 of Nov. 12, 1996). This device is chosen as the prototype.

Among the shortcomings of the prototype device are the following:

1. High metal content of the device. Take for instance a tank RVS-5000 which has a 22.8 m oil “mirror” diameter and an 11.92 m column height. According to the prototype patent specification, the number of ring pipelines is 3\sqrt{dₚₑ₃}, i.e., in our case the number of ring pipelines will be

3\sqrt{228}=2.83

i.e., 3 ring pipelines, wherein the one with the largest radius is at least 1 m away from the VST inner wall, i.e., the maximum ring diameter is ≈21 m, the middle diameter is ≈14 m, and the inner diameter is ≈7 m. The three rings are connected by means of at least six intersecting radial pipes, i.e., there are six more 21 m long pipes. At the intersections of ring and radial pipes there are vertical discharge pipes, ≈11 m high. There are 13 more pipes, 11 m long each. Thus, the total length of the pipelines is L=π [symbol] 1+π [symbol] 2+π [symbol] 3+ [symbol] 1+13×11 m=66 m+44 m+22 m+126 m+143 m=401 m. The inside diameter of a pipeline is 200 mm for foam quenching and 50 mm for powder quenching. The weight of a foam-quenching steel pipeline with a 5 mm thick wall would be 9.6 t, and for a powder-quenching system with a 3 mm thick wall the pipeline weight alone would be 1.5 t.
2. The nozzle sprinklers are rigidly fixed above the uppermost level of the liquid at a height of 0.15-0.3 m. But the FL column height in an RVS-5000 tank can be 11.5 m, i.e., as FL or HIL in the tank are consumed, quenching conditions are different because it is much harder to deliver a jet to a burning surface from a height of 11.5 m due to the loss of a jet's kinetic energy, as well as due to the countercurrent flow of vaporizing FL and/or FL combustion products.
3. During fires in VSTs with a fixed or floating roof, there is practically always combustion of vapors in the VST and, as a rule, a breakdown of the rigid roof and automatic fire extinguishing units installed in the upper section of the VST (see Sharovarnikov, I. F., Molchanov, V. P., et al. [symbol] [symbol] [symbol] [symbol] [Extinguishing Fires of Oil and Petroleum Products], Moscow, “Kalan” Publishing House, 2002, p. 437).
4. Another significant shortcoming of the prototype device is high specific consumption of the FES when feeding it to the fire zone from above (see A. N. Baratov and Ye. M. Ivanov. [symbol] [symbol] [symbol] [symbol] [symbol] [symbol] [symbol] [Fire Fighting at Chemical and Petrochemical Enterprises], Moscow, “Khimiya” Publishing House, 1979, p. 368, and also the above referenced source: Sharovarnikov, I. F., Molchanov, V. P., et al. [symbol] [symbol] [symbol] [symbol] [Extinguishing Fires of Oil and Petroleum Products], Moscow, “Kalan” Publishing House, 2002, p. 437). According to information from the above reference sources, consumption of a sodium bicarbonate-based fire-extinguishing substance and ammonium phosphate-based powder is between 1.5 kg/m² and 4.5 kg/m², and for foam it is between 1.4 kg/m² and 2.6 kg/m².

The objective of the invention is to develop a method and device that is resistant to explosion of oil and petroleum product vapors in tanks and improve the efficiency of extinguishing fires in tanks by reducing the extinguishing time and the device's metal content.

The stated objective is solved by implementing the claimed method and device for quenching FL in tanks with a fixed roof, namely, by feeding a gaseous or gas-dispersion fire-extinguishing mixture from a modular fire-extinguishing device (injector) located outside the tank via an OCD, a discharge pipeline, and a sprinkler, into the fire zone from a floating sprinkler surface to the surface of the burning liquid, wherein fire extinguishing comprises three steps:

first step: said floating sprinkler is installed under the level of burning fuel at a depth equal to at least the sprinkler height, and/or on the surface of said liquid, wherein the pipeline length is found from the following relation:

[symbol]

where
Lₜₚ is the length of the pipeline connecting the injector to the floating sprinkler (the pipeline length from the point of entry into the tank to the point of connection with the floating sprinkler), m;
Rₚ is the tank radius, m; [symbol]
is the maximum level of flammable liquid in the tank, m; [symbol]
is the height of the entry point of the discharge pipeline from the injector into the tank, m; and
Hpacn is the sprinkler height, m;

second step: after a fire alarm signal is sent, the opening-closing device on the injector is opened, and said fire-extinguishing mixture is fed from the injector to the discharge pipeline and floating sprinkler, wherein the fire-extinguishing mixture is fed from the latter under the liquid layer and/or onto the liquid surface in the form of compact jets from the center to the periphery, parallel to the horizon with a 360° sweep, and a 0.05-0.2 portion of said fire-extinguishing mixture is sprinkled through nozzles at a 3°-90° angle to the surface of the liquid burning in the tank, in order to create a lift that provides positive buoyancy of the “discharge pipeline—floating sprinkler” assembly;

third step: the floating sprinkler surfaces above the burning surface to a height of 0.005-0.05 of the tank diameter, the fire-extinguishing mixture is fed at a rate of at least 0.15 kg/s×m² with a circular sweep of jets, and the number of jets is found from the following expression:

$$\frac{90 °}{α} \leq n \leq \frac{360 °}{α}$$

r [symbol] e n is the number of jets, and
α is the stream divergence angle.

The sprinkler can be pre-installed above the surface of the burning liquid layer.

As a gas-dispersion fire-extinguishing mixture, one uses a dispersed composition comprising a highly dispersed additive, a special additive for fluidity, an organosilicon water repellent agent, a main powdery fire retardant, and a gaseous and/or liquefied phlegmatizer, or a mixture of a phlegmatizer and a liquid retardant; where as a gaseous and/or liquefied phlegmatizer, one uses carbon dioxide, or a mixture of carbon dioxide and nitrogen or air, in a ratio between 9:1 and 4:1, or a mixture of carbon dioxide and alkylcarbinol in a ratio between 99:1 [symbol] o 90:10, or a mixture of carbon dioxide and nitrogen or air with alkylcarbinol in a ratio of (80-100):(5-20):(0.5-5); and as a liquid fire retardant, one uses a 5% alkylcarbinol solution of iodine or a 5-20% alkylcarbinol solution of a mixture of iodine and alkaline metal iodide or ammonium iodide, wherein the ratio in the phlegmatizer—liquid retardant mixture is between 100:1 and 100:30, and carbon dioxide is modified with dimethylketone between 100:1 to 10:1, with the following ratio of the components, mass %:

finely dispersed additive—0.2-2.8;
special additive for fluidity—4.6-25;
organosilicon water repellent agent—0.1-0.7;
main powder fire retardant—15-85;
phlegmatizer or a mixture of phlegmatizer and liquid retardant—the rest;
and as a gaseous fire-extinguishing mixture, one uses a fire-extinguishing composition comprising compressed propellant gases (nitrogen, argon, inergen or their mixture with air) and liquefied gases (carbon dioxide, sulfur hexafluoride, halons or their mixtures), with the following ratio of compressed and liquefied gases, mass. %:
compressed gases—6.6-60
liquefied gases—the rest.

The device for quenching oil and petroleum products and flammable and highly inflammable liquids in a tank (injector) located outside the tank comprises a vessel with a fire-extinguishing dispersed or liquefied gaseous composition and a vessel with a gaseous phlegmatizer-propellant, or a vessel with a combined fire-extinguishing dispersed or gaseous composition and a propellant gas that makes injection of said fire-extinguishing compositions through the opening-closing device and a discharge pipeline with a sprinkler into the tank into the fire zone possible, and is distinct in that outside the tank the discharge pipeline is connected to the injector by means of a hinge and the opening-closing device, and at the other end, it is connected to the sprinkler by means of a hinge and a float with adjustable buoyancy that enables the sprinkler to float up during fire extinguishing and sprinkler placement above the burning surface at a height of 0.005-0.05 of the tank diameter, wherein the sprinkler has at least one tier of nozzle holes located in a horizontal plane with a 360° sweep.

The sprinkler nozzle holes are made in the form of diffusers, with 80-95% of the holes located in a horizontal plane and 5-20% of the holes located at the 3°-90° angle to the latter, and the total number of diffuser nozzles is derived from the following formula:

$$\frac{90 °}{\underline{α}} \leq n \leq \frac{360 °}{α}$$

where n is the number of diffusers, and
α is the diffuser angle.

The opening-closing device is made with electric, and/or pneumatic, and/or manual start, with regular or dust-ignition-proof construction.

Physical Essence of Invention. The work by V. V. Pomerantsev, K. M. Arefev, D. B. Akhmedov et al. [symbol] [symbol] [symbol] [symbol] [Fundamentals of the Practical Theory of Combustion], Textbook for Students of Institutions of Higher Education, Leningrad, “Energiya” Publishing House, 1973, p. 262) states that:

1. Liquid fuel always burns in the vapor phase.
2. Heat supplied from a flame to a liquid surface is spent for heating the liquid in the interface layer, evaporating the liquid and heating the vapors.
3. It can be assumed for practical purposes that the surface temperature of a burning liquid is equal to the liquid boiling point.
4. There is a very strong temperature dependence of saturated vapor pressure of oil and petroleum products. A slight decrease of flammable liquid temperature results in a considerable decrease of saturated vapor pressure.
5. The main heat release during burning of a flammable liquid takes place in the luminous zone (flame).
6. Liquid heating is due to radiation heat (radiation) coming from the upper layers of a flame, and, according to the Stefan-Boltzmann law, radiation intensity is directly proportional to the fourth degree of temperature: [symbol] ≈σT4 W/sr.

It follows from the above that to effectively stop the burning of oil and petroleum products, the following actions are required:

1. Reduce the temperature of the liquid burning surface.
2. Reduce vapor pressure of oil and petroleum products.
3. Isolate (reduce) heat release from the burning zone (flame) to the heated zone.

All these actions are made possible when using the claimed method for quenching and the above described device.

Namely: 1) feeding cooled gas-dispersed mixture (liquid CO₂+fire-extinguishing powder) into the interface liquid layer and/or under the liquid layer considerably reduces the temperature of the heated layer;
2) reducing heat radiation from the flame to the surface of oil and petroleum products due to the creation of aerosol cloud between the interface liquid layer and the flame luminous zone. Attenuation of radiation follows the Bouguer-Lambert-Baire's law:

φ [symbol] =φo×e−ε×c×l (1)

where
φ [symbol] is heat flow that has passed through the aerosol layer, W/sr;
φ0 is flame radiation heat flow, W/sr
e is the base of natural logarithms,
ε is attenuation of radiation, m²/g,
c is aerosol concentration in the layer, g/m³, and
l is the aerosol layer thickness, m.

By way of example, we shall calculate the ratio of attenuation of heat radiation in the 0.8-14 m band of electromagnetic radiation spectrum during fire at an RVS-5000 when using the aerosol protection (AP) method. The RVS-5000 diameter is 21.1 m; the oil “mirror” area is 356 m². We install 6 modules MPP [symbol] BiZone-100 [symbol] (2 for each foam pourer KNP-5) around the VST. The total amount of phosphate-based powder is 480 kg. The time for discharging the gas-dispersion mixture from the modules is ≈6 seconds. We assume that in 1 second we “cover” the entire VST area (S=356 m²) with a 1 m thick aerosol layer. Then, powder concentration in the aerosol is

$${C}_{A 3} = \frac{{( 480 : 6 )}_{K Γ}}{{356}_{{M}^{2}} \cdot {1}_{M}} = 0 , {22}_{K Γ / {M}^{3}} = {200}_{Γ / {M}^{3}}$$

The coefficient of attenuation ε0.8-14 in the IR band (0.8-14 m) for ammonium primary phosphate powder is approximately 0.05-0.1 m²/g, depending on its degree of dispersion.

Take the average value of the coefficient of attenuation ε0.8-14=0.075 m²/g. Hence, transforming the expression (1), we derive:

K=φ/φ0=eεcl, (2)

where ε0.8-14 is the coefficient of attenuation of electromagnetic radiation (EMR) in the 0.8-14 μm band,
m2/r,
c is volumetric mass concentration of aerosol, g/m³,
l is the aerosol cloud thickness along the line of sight view, m.

Substituting the above parameter values in the expression (2), we derive

K=φ/φ0=e0 075×220×1=1.46×10⁷,

i.e., we practically shroud flame radiation.

### SUMMARY

The invention is realized as follows. The mixing of powder components and production of dry powder fire retardant is performed using the equipment and technology established in manufacturing fire extinguishing powders. The resulting dry fire retardant is filled into a powder vessel (cylinder) using a type PSM charging station, and a phlegmatizing propellant gas, a liquefied retardant and a liquefied phlegmatizer modifier, are filled into the vessel—the gas source of the devise using a charging station ZSA.

During the operation of the claimed device, the dispersed and gaseous components mix and form a gas-dispersion fire-extinguishing mixture injected into the combustion zone according to the invention.

Tables 1-3 show examples of compositions for filling the devices per the invention, and the test results in quenching oil and petroleum products using the method and device on a mockup fire source 233V.

The method is realized as follows. A gas-dispersion fire-extinguishing module (type BiZone-100) is installed outside a VST, VSTFR [vertical steel tank with a floating roof], or VSTP tank next to the tank inlet pipe. The BiZone-100 (injector) is connected through the opening-closing device by means of a flexible (hinged or other) or rigid pipeline with a floating sprinkler that is installed under the layer of the burning liquid in the tank or on the surface of said liquid according to claim 1. Then, according to the claims, after a fire alarm signal is sent, the opening-closing device is opened, and fire extinguishing is performed through the discharge pipeline and sprinkler in two steps. A FES is fed first under the layer and/or onto the surface of the burning liquid, and then above the FL surface at a height of 0.005-0.05 of the VST diameter.

### DRAWINGS

FIG. 1 shows the device for quenching oil and petroleum products in a VST with a fixed roof without a pontoon in the standby mode;

FIG. 2 shows the same device in the operating mode (during fire extinguishing);

FIG. 3 shows the device for quenching oil and petroleum products in a VST with a fixed roof and a pontoon in the standby mode;

FIG. 4 shows the same device in the operating mode;

FIG. 5 shows a circular sprinkler with a float;

FIG. 6 shows the external view of the hinge joint; and

FIG. 7 shows the hinge schematically.

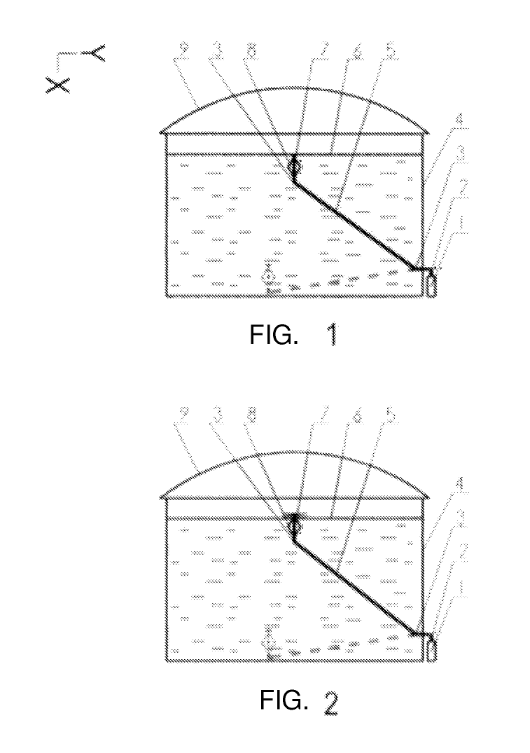

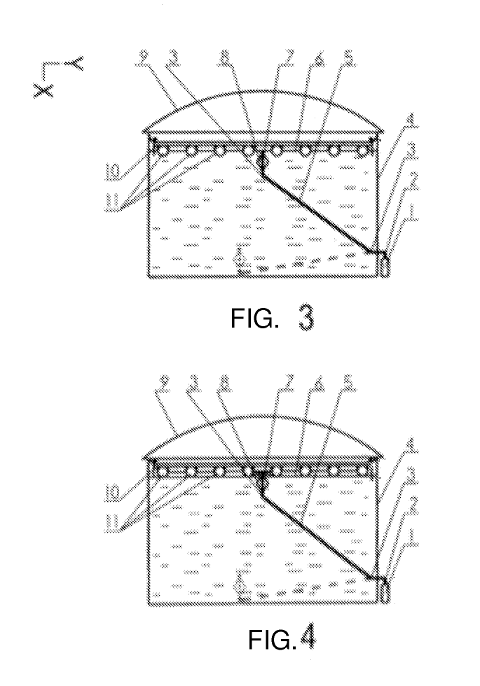

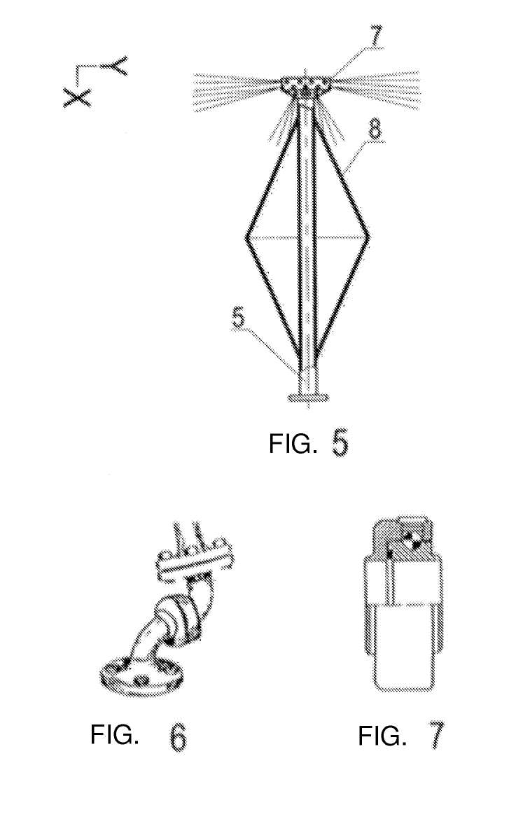

### REFERENCE NUMBERS

1—gas-dispersion mixture injector,
2—opening-closing device,
3—hinges,
4—VST shell,
5—discharge pipeline,
6—oil or petroleum products,
7—circular sprinkler,
8—sprinkler float,
9—fixed roof,
10—floating pontoon,
11—pontoon float.

### DESCRIPTION

According to the claimed invention, the device 6 for quenching oil and petroleum products in vertical steel tanks (VST) with a fixed roof 9 and in VST with a pontoon (VSTP) 10 works as follows.

When a fire breaks out, a signal from a fire alarm thermostat arrives at the monitoring and triggering device of the fire extinguishing system. It arrives from the system in the form of an electric or pneumatic signal at the opening-closing device (OCD) 2 located in a cylinder with a phlegmatizing propellant gas of the injector 1. Then, the phlegmatizer gas enters a vessel with a dispersed chemical retardant, and going through the retardant it forms a fire-extinguishing gas-dispersion mixture shown in Tables 1-21. Through the discharge pipeline 5 and hinge joints 3 the mixture enters the circular sprinkler 7. From there, the gas-dispersion mixture propagates under the layer 6 parallel to it and cools and phelgmatizes it, while a portion (5-20%) of the gas-dispersion mixture coming out of the sprinkler at a rate of at least 0.15 kg/s×m² creating positive buoyancy of the float 8; this enables the lifting of the “circular sprinkler—hinge—discharge pipeline” cantilever beam and, finally, the surfacing of the circular sprinkler, thereby feeding the fire-extinguishing gas-dispersion mixture onto the burning surface 6 or under the pontoon 10 with floats 11.

It is possible to pre-install the sprinkler above the surface of the burning liquid layer.

As can be seen from the above data and test results shown in Tables 1-21, the present method and device compares favorably to the prototype method and prototype device in terms of:

effective fire extinguishing time, which is shorter by a factor of 1.3-50;
specific metal consumption, which is reduced by a factor of 1.1-14.
And the method and device provides a new positive feature—resistance to explosion of oil, petroleum products and flammable and highly inflammable liquids.

TABLE 1

| | Prototype | | Components Content, mass % | | | | | | | |
|---|---|---|---|---|---|---|---|---|---|---|
| | Method | Device | Embodiment | | | | | | | |
| Components | RU 2258549 | US 5573068 | 1 | 2 | 3 | 4 | 5 | 6 | 7 | 8 |

| 1 | 2 | 3 | 4 | 5 | 6 | 7 | 8 | 9 | 10 |
|---|---|---|---|---|---|---|---|---|---|
| 1. Finey dispersed additive (silicon oxide) | 0.2-2.8 | 0.2 | 1 | 2.8 | 0.2 | 1.0 | 2.8 | 0.2 | 1.0 |
| 2. Special additive for fluidity | 4.6-25.0 | 25 | 10 | 4.6 | 25 | 10 | 4.6 | 25 | 10 |
| 3. Organosilicon water repellent | 0.1-0.7 | 0.7 | 0.3 | 0.1 | 0.7 | 0.3 | 0.1 | 0.7 | 0.3 |
| 4. Main powder fire retardant | 15-85 | | | | | | | | |
| 4.1 Potassium chloride | | 15 | 50 | 85 | — | — | — | — | — |
| 4.2 Potassium sulfate | | — | — | — | 15 | 50 | 85 | — | — |
| 4.3 Potassium carbonate | | — | — | — | — | — | — | 15 | 50 |
| 4.4 Sodium bicarbonate | | — | — | — | — | — | — | — | — |
| 4.5 Ammophos | | — | — | — | — | — | — | — | — |
| 4.6 Diammonium phosphate | | — | — | — | — | — | — | — | — |
| 5. Mixture of carbon dioxide, nitrogen and | Rest to 100% | — | | | — | | | — | |
| halogen hydrocarbon | | | | | | | | | |
| 6. Mixture of dimethylketone-modified carbon | — | Rest | Rest | Rest | Rest | Rest | Rest | Rest | Rest |
| dioxide in the ratio of 10:1, and nitrogen in the | | to | to | to | to | to | to | to | to |
| ratio of 95:5 | | 100% | 100% | 100% | 100% | 100% | 100% | 100% | 100% |
| 7. Fire extinguishing time at mixture feeding rate | 1.5-20 | 1.5-20 | | | 0.8-1.4 | | | 0.7-1.3 | |
| I = 0.15 kg/s × m² | | | | | | | | | |
| 8. Specific metal consumption per 1 m² of | 0.47-4.34 | 0.31-0.42 | | | 0.31 | | | 0.42 | |
| protected area, kg/m² | | | | | | | | | |
| 9. Resistance to explosion of FL and HIL vapors, | − | + | + | + | + | + | + | + | + |
| Yes—(+) | | | | | | | | | |
| No—(−) | | | | | | | | | |

| | Components Content, mass % | | | | | | | | | |
|---|---|---|---|---|---|---|---|---|---|---|
| | Embodiment | | | | | | | | | |
| Components | 9 | 10 | 11 | 12 | 13 | 14 | 15 | 16 | 17 | 18 |
| 1 | 11 | 12 | 13 | 14 | 15 | 16 | 17 | 18 | 19 | 20 |
| 1. Finey dispersed additive (silicon oxide) | 2.8 | 0.2 | 1.0 | 2.8 | 0.2 | 1.0 | 2.8 | 0.2 | 1.0 | 2.8 |
| 2. Special additive for fluidity | 4.6 | 25 | 10 | 4.6 | 25 | 10 | 4.6 | 25 | 10 | 4.6 |
| 3. Organosilicon water repellent | 0.1 | 0.7 | 0.3 | 0.1 | 0.7 | 0.3 | 0.1 | 0.7 | 0.3 | 0.1 |
| 4. Main powder fire retardant | | | | | | | | | | |
| 4.1 Potassium chloride | — | — | — | — | — | — | — | — | — | — |
| 4.2 Potassium sulfate | — | — | — | — | — | — | — | — | — | — |
| 4.3 Potassium carbonate | 85 | — | — | — | — | — | — | — | — | — |
| 4.4 Sodium bicarbonate | — | 15 | 50 | 85 | — | — | — | — | — | — |
| 4.5 Ammophos | — | — | — | — | 15 | 50 | 85 | — | — | — |
| 4.6 Diammonium phosphate | — | — | — | — | — | — | — | 15 | 50 | 85 |
| 5. Mixture of carbon dioxide, nitrogen and | — | — | | | — | | | — | | |
| halogen hydrocarbon | | | | | | | | | | |
| 6. Mixture of dimethylketone-modified carbon | Rest | Rest | Rest | Rest | Rest | Rest | Rest | Rest | Rest | Rest |
| dioxide in the ratio of 10:1, and nitrogen in the | to | to | to | to | to | to | to | to | to | to |
| ratio of 95:5 | 100% | 100% | 100% | 100% | 100% | 100% | 100% | 100% | 100% | 100% |
| 7. Fire extinguishing time at mixture feeding rate | 0.7-1.3 | 0.9-1.45 | | | 0.4-1.4 | | | 0.5-1.4 | | |
| I = 0.15 kg/s × m² | | | | | | | | | | |
| 8. Specific metal consumption per 1 m² of | 0.42 | 0.31 | | | 0.42 | | | 0.31 | | |
| protected area, kg/m² | | | | | | | | | | |
| 9. Resistance to explosion of FL and HIL vapors, | + | + | + | + | + | + | + | + | + | + |
| Yes—(+) | | | | | | | | | | |
| No—(−) | | | | | | | | | | |

TABLE 2

| | Prototype | | Components Content, mass % | | | | | | | | |
|---|---|---|---|---|---|---|---|---|---|---|---|
| | Method | Device | Embodiment | | | | | | | | |
| Components | RU 2258549 | US 5573068 | 361 | 362 | 363 | 364 | 365 | 366 | 367 | 368 | 369 |

| 1 | 2 | 3 | 4 | 5 | 6 | 7 | 8 | 9 | 10 | 11 |
|---|---|---|---|---|---|---|---|---|---|---|
| 1. Finey dispersed additive (silicon oxide) | 0.2-2.8 | 0.2 | 1 | 2.8 | 0.2 | 1.0 | 2.8 | 0.2 | 1.0 | 2.8 |
| 2. Special additive for fluidity | 4.6-25.0 | 25 | 10 | 4.6 | 25 | 10 | 4.6 | 25 | 10 | 4.6 |
| 3. Organosilicon water repellent | 0.1-0.7 | 0.7 | 0.3 | 0.1 | 0.7 | 0.3 | 0.1 | 0.7 | 0.3 | 0.1 |
| 4. Main powder fire retardant | 15-85 | | | | | | | | | |
| 4.1 Potassium chloride | | 15 | 50 | 85 | — | — | — | — | — | — |
| 4.2 Potassium sulfate | | — | — | — | 15 | 50 | 85 | — | — | — |
| 4.3 Potassium carbonate | | — | — | — | — | — | — | 15 | 50 | 85 |
| 4.4 Sodium bicarbonate | | — | — | — | — | — | — | — | — | — |
| 4.5 Ammophos | | — | — | — | — | — | — | — | — | — |
| 4.6 Diammonium phosphate | | — | — | — | — | — | — | — | — | — |
| 5. Mixture of carbon dioxide, nitrogen and | Rest to 100% | — | | | — | | | — | | |
| halogen hydrocarbon | | | | | | | | | | |
| 6. Mixture of dimethylketone-modified carbon dioxide | | Rest to 100% | | | Rest to 100% | | | Rest to 100% | | |
| in the ratio of 00:1, with nytrogen, with propylcarbinol | | | | | | | | | | |
| and 20% propylcarbinol solution of mixture of iodine and | | | | | | | | | | |
| ammonium iodide in the ratio of 85:12.5: 2.5 | | | | | | | | | | |
| 7. Fire extinguishing time at mixture feeding rate | 1.5-20 | 1.5-20 | | | 0.8-1.4 | | | 0.7-1.3 | | |
| I = 0.15 kg/s × m² | | | | | | | | | | |
| 8. Specific metal consumption per 1 m² of | 0.47-4.34 | 0.31-0.42 | | | 0.31-0.42 | | | 0.31-0.42 | | |
| protected area, kg/m² | | | | | | | | | | |
| 9. Resistance to explosion of FL and HIL vapors, | − | + | + | + | + | + | + | + | + | + |
| Yes—(+) | | | | | | | | | | |
| No—(−) | | | | | | | | | | |

| | Components Content, mass % | | | | | | | | |
|---|---|---|---|---|---|---|---|---|---|
| | Embodiment | | | | | | | | |
| Components | 370 | 371 | 372 | 373 | 374 | 375 | 376 | 377 | 378 |
| 1 | 12 | 13 | 14 | 15 | 16 | 17 | 18 | 19 | 20 |
| 1. Finey dispersed additive (silicon oxide) | 0.2 | 1.0 | 2.8 | 0.2 | 1.0 | 2.8 | 0.2 | 1.0 | 2.8 |
| 2. Special additive for fluidity | 25 | 10 | 4.6 | 25 | 10 | 4.6 | 25 | 10 | 4.6 |
| 3. Organosilicon water repellent | 0.7 | 0.3 | 0.1 | 0.7 | 0.3 | 0.1 | 0.7 | 0.3 | 0.1 |
| 4. Main powder fire retardant | | | | | | | | | |
| 4.1 Potassium chloride | — | — | — | — | — | — | — | — | — |
| 4.2 Potassium sulfate | — | — | — | — | — | — | — | — | — |
| 4.3 Potassium carbonate | — | — | — | — | — | — | — | — | — |
| 4.4 Sodium bicarbonate | 15 | 50 | 85 | — | — | — | — | — | — |
| 4.5 Ammophos | — | — | — | 15 | 50 | 85 | — | — | — |
| 4.6 Diammonium phosphate | — | — | — | — | — | — | 15 | 50 | 85 |
| 5. Mixture of carbon dioxide, nitrogen and | — | | | — | | | — | | |
| halogen hydrocarbon | | | | | | | | | |
| 6. Mixture of dimethylketone-modified carbon dioxide | Rest to 100% | | | Rest to 100% | | | Rest to 100% | | |
| in the ratio of 00:1, with nytrogen, with propylcarbinol | | | | | | | | | |
| and 20% propylcarbinol solution of mixture of iodine and | | | | | | | | | |
| ammonium iodide in the ratio of 85:12.5: 2.5 | | | | | | | | | |
| 7. Fire extinguishing time at mixture feeding rate | 0.9-1.45 | | | 0.4-1.4 | | | 0.5-1.4 | | |
| I = 0.15 kg/s × m² | | | | | | | | | |
| 8. Specific metal consumption per 1 m² of | 0.31-0.42 | | | 0.31-0.42 | | | 0.31-0.42 | | |
| protected area, kg/m² | | | | | | | | | |
| 9. Resistance to explosion of FL and HIL vapors, | + | + | + | + | + | + | + | + | + |
| Yes—(+) | | | | | | | | | |
| No—(−) | | | | | | | | | |

TABLE 3

| | Prototype | | Components Content, mass % | | | | |
|---|---|---|---|---|---|---|---|
| | Method | Embodiment | Embodiment | | | | |
| Components | RU 2258549 | US 5573068 | 379 | 380 | 381 | 382 | 383 |

| 1 | 2 | 3 | 4 | 5 | 6 | 7 |
|---|---|---|---|---|---|---|
| 1. Finey dispersed additive (silicon oxide) | 0.2-2.8 | — | — | — | — | — |
| 2. Special additive for fluidity | 4.6-25.0 | — | — | — | — | — |
| 3. Organosilicon water repellent | 0.1-0.7 | — | — | — | — | — |
| 4. Main powder fire retardant | 15-85 | — | — | — | — | — |
| 5. Mixture of carbon dioxide, nitrogen and | Rest to 100% | — | — | — | — | — |
| halogen hydrocarbon | | | | | | |
| 6. Compressed gas - air | — | 6.5 | 6.6 | 30 | 60 | 61 |
| 7. Compressed gas - carbon dioxide | — | 93.5 | 95.4 | 70 | 40 | 39 |
| 8. Fire extinguishing time at mixture feeding rate | 15-20 | 2-3.5 | 0.9-1.45 | 0.7-1.3 | 0.8-1.4 | 2.5-20 |
| I = 0.15 kg/s × m² | | | | | | |
| 9. Specific metal consumption per 1 m² of | 0.47-4.34 | 0.31-0.42 | 0.31-0.42 | 0.31-0.42 | 0.31-0.42 | 0.31-0.42 |
| protected area, kg/m² | | | | | | |
| 10. Resistance to explosion of FL and HIL | − | + | + | + | + | + |
| vapors, | | | | | | |
| Yes—(+) | | | | | | |
| No—(−) | | | | | | |

The following are claimed:

1. A method for quenching oil and petroleum products in a tank by feeding a gaseous or gas-dispersion fire-extinguishing mixture from a fire-extinguishing injector located outside the tank, through an opening-closing device, a discharge pipeline, and a sprinkler, into the fire zone, wherein said fire-extinguishing mixture is fed from a floating sprinkler surfacing above the burning liquid surface, wherein fire extinguishing comprises three steps:
first step: the floating sprinkler connected to the pipeline via the opening-closing device with the injector is installed under the burning liquid layer at a depth equal to at least the sprinkler height and/or on the surface of said liquid, with the pipeline length determined from the following relationship:
L_{Tp}= [symbol] , where
LTp is the pipeline length, m;
Rₚ is the tank radius, m; [symbol]
is the maximum level of flammable liquid in the tank, m; [symbol]
is the height of the entry point of the discharge pipeline from the injector into the tank, m; and
Hpacn is the sprinkler height, m;
second step: after a fire alarm signal is sent, the opening-closing device on the injector is opened, and said fire-extinguishing mixture is fed through the discharge pipeline and floating sprinkler under the layer and/or onto the surface of the burning liquid in the form of compact jets from the center to the periphery, parallel to the horizon with a 360° sweep, and a 0.05-0.2 portion of said fire-extinguishing mixture is directed at a 3°-90° angle to the liquid surface; and
third step: the floating sprinkler surfaces above the surface of the burning liquid to a height of 0.005-0.05 of the tank diameter, the fire-extinguishing mixture is fed at a rate of at least 0.15 kg/s×m², with a circular sweep of jets, and the number of jets is found from the following expression:
$$\frac{90 °}{\underline{α}} \leq n \leq \frac{360 °}{α}$$
where
n is the number of jets, and
α is the stream divergence angle.

2. The method of claim 1 wherein, as a gas-dispersion fire-extinguishing mixture, one uses a disperse fire-extinguishing composition comprising a finely dispersed additive, a special additive for fluidity, an organosilicon water repellent agent, a main powder fire retardant, and a gaseous and/or liquefied phlegmatizer or a mixture of a phlegmatizer and a liquid retardant; where as a gaseous and/or liquefied phlegmatizer, one uses carbon dioxide, or a mixture of carbon dioxide and nitrogen or air in a ratio between 9:1 and 4:1, or a mixture of carbon dioxide and alkylcarbinol in a ratio between 99:1 and 90:10, or a mixture of carbon dioxide and nitrogen or air with alkylcarbinol in a ratio of (80-100):(5-20):(0.5-5); and as a liquid fire retardant, one uses a 5% alkylcarbinol solution of iodine or a 5-20% alkylcarbinol solution of a mixture of iodine and alkaline metal iodide or ammonium iodide, wherein the ratio in the phlegmatizer—liquid retardant mixture is between 100:1 and 100:30, and carbon dioxide is modified with dimethylketone between 100:1 to 10:1, with the following ratio of components, mass %:
finely dispersed additive—0.2-2.8;
special additive for fluidity—4.6-25;
organosilicon water repellent agent—0.1-0.7;
main powder fire retardant—15-85;
phlegmatizer or a mixture of phlegmatizer and liquid retardant—the rest;
and as a gaseous fire-extinguishing mixture, one uses a fire-extinguishing composition comprising compressed propellant gases, such as nitrogen, argon, inergen or their mixture with air, and liquefied fire-extinguishing gases such as carbon dioxide, sulfur hexafluoride, halons or their mixtures, with the following ratio of compressed and liquefied gases, mass. %:
compressed gases—6.6-60
liquefied gases—the rest.

3. A device for quenching oil and petroleum products in a tank located outside the tank and comprising a vessel with fire-extinguishing dispersed or liquefied gas composition and a vessel with a gaseous phlegmatizer-propellant, or a vessel with a combined fire-extinguishing dispersed or gaseous composition and propellant that enables injection of said fire-extinguishing composition through an opening-closing device and a discharge pipeline with an injector into the tank into the fire zone, wherein, outside the tank, the discharge pipeline is connected to the injector by means of a hinge and the opening-closing device, and at the other end, the discharge pipeline is connected to the injector by means of a hinge and a float with adjustable buoyancy, wherein the sprinkler has at least one tier of nozzle holes located in a horizontal plane with a 360° sweep.

4. The device of claim 3 wherein the nozzle holes are made in the form of diffusers, with 80-95% of the holes located in a horizontal plane and 5-20% of the holes located at the 3°-90° angle to the latter, and the total number of the diffuser nozzles is derived from the following formula:
$$\frac{90 °}{\underline{α}} \leq n \leq \frac{360 °}{α}$$
where
n is the number of diffusers, and
α is the diffuser angle.

5. The device per claim 3 wherein the opening-closing device is made with an electric, and/or pneumatic, and/or manual start, with regular or dust-ignition-proof construction.
